(19) United States
(12) Patent Application Publication
(10) Pub. No.: US 2003/0068608 A1
(43) Pub. Date: Apr. 10, 2003

(54) Method and system for learning an implementation of a measurement sequence for operating a medical-technical apparatus

(75) Inventors: Rainer Kuth, Herzogenaurach (DE); Christoph Zindel, Uttenreuth (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/263,108

(22) Filed: Oct. 2, 2002

(30) Foreign Application Priority Data
Oct. 4, 2001 (DE) 10148 837.8

(51) Int. Cl. G09B 23/28

(52) U.S. Cl. 434/262; 434/350; 434/362

(57) ABSTRACT

In a method and system for learning the implementation of a measurement sequence for the operation of a medical-technical system, a web page is stored in an Internet server that can be downloaded with a computer connected to the Internet and viewed with a viewing device of the computer.

### BACKGROUND OF THE INVENTION

1. Field of the Invention

The present invention is directed to a method for learning the implementation of a measurement sequence for the operation of medical-technical system. The invention also is directed to a system having a web page stored in an Internet server that is downloaded with a computer connected to the Internet and can be viewed with a viewing device of the computer.

2. Description of the Prior Art

Tele-learning is a term used to describe techniques wherein a learnee does not physically attend a learning institution but, for example, studies learning material at home, for example with the Internet. Thus, for example, the “Burgerliches Recht and Unternehmensrecht” (Civil Law and Corporate Law) faculty of the FernUniversität Gesamthochschule in Hagen (i.e. a teleuniversity) offers a course about the general part of the BGB (Bundesgesetsbuch, German Federal Code) the Internet as well, at least in part. A student can contact a web page maintained by the “Bürgerliches Recht and Unternehmensrecht” faculty with a computer connected to the Internet in order to read the content of the web page.

Follow-up training for an operator of a medical-technical system, however, is conventionally implemented by means of attendance seminars. In such attendance seminars, for example, the operator is taught a new operating sequence for, for example, the implementation of a new measurement sequence for a magnetic resonance apparatus. An attendance seminar is offered in only few instances in the proximity of the place that the operator lives or works, so that the operator must accept a long commute if the operator wishes to participate in the attendance seminar.

### SUMMARY OF THE INVENTION

It is an object of the invention to provide a method and a system that allow an operator of the medical-technical system to learn a new operating sequence for the medical-technical system in a simple way.

The above object is achieved in accordance with the invention in a method for learning the implementation of a measurement sequence for the operation of a medical-technical system including the following method steps:

a) maintaining a first web page on an Internet server, the first web page having a description of the implementation of the measurement;

b) communicating the first web page to a computer connected to the Internet, so that the first web page can be displayed with a viewing device of the computer;

c) maintaining a second web page on the Internet server, the second web page having at least one check query about the implementation of the measurement sequence; and

d) communicating the second web page to the computer connected to the Internet, so that the second web page can be displayed with the viewing device of the computer.

According to the inventive method, thus, the first web page is offered on the Internet server, and the first web page contains a description of the implementation of the measurement sequence. A measurement sequence is, for example, a measurement sequence of a magnetic resonance apparatus. Subsequently, the first web page is communicated to the computer connected to the Internet. Thus, for example, an operator of the medical-technical system can read the implementation of the measurement sequence with the viewing device of the computer. The second web page, which contains at least one check query about the implementation of the measurement sequence then is offered. The second web page likewise can be viewed by the operator with the viewing device of the operator's computer and can check the comprehension of the measurement sequence, so that the operator can subsequently implement the measurement sequence, i.e. operate the medical-technical system such that the medical-technical system implements the measurement sequence. As a result of the inventive method, thus, the operator no longer need attend an attendance seminar when the operator would like to learn a new measurement sequence for the medical-technical system that the operator operates. As a result of the inventive method, the operator instead can study the implementation of the measurement sequence, for example, at home. The inventive method is particularly advantageous when it is employed for follow-up training of the operator and/or for learning a new measurement sequence.

In a version of the invention, points according to a prescribed point system are awarded on the basis of an answer to the check query communicated to the Internet server. The awarding of the point system corresponds, for example, to an evaluation of the answer and thus can serve as an indication of the operator's comprehension of the implementation of the measurement sequence.

In a preferred embodiment of the invention, the points are forwarded from the Internet server to an accreditation entity such as a physicians' board or to a professional medical society. A physicians' board or a professional medical society thus can check in a simple as to whether, for example, the operator or operators of medical-technical systems are receiving follow-up training.

In another version of the invention, the check query is automatically selected from a query catalogue according to a random technique and/or the check query is required to be answered within a predetermined time duration. Consequently, a testing situation can be simulated. The inventive method therefore can also be employed for testing purposes given follow-up training. In contrast to an attendance seminar wherein, for example, an examination is held at the end of and at the location of the attendance seminar, the examination student, i.e. the operator of the medical-technical system, need not accept an long commuting times in order to be able to participate in the examination. On the contrary, the examination student can take the test, for example, at home.

In a further version of the invention, the medical-technical system is a magnetic resonance apparatus.

The above object also is achieved in accordance with the invention in a system with a web page stored in an Internet server that can be downloaded with a computer connected to the Internet and displayed with a viewing device of the computer, wherein that the web page contains a description of the implementation of a measurement sequence of a medical-technical system, and wherein comprehension of the implementation of the measurement sequence can be checked with at least one check query. The web page containing the description of the implementation or a further web page that is stored in the Internet server and can be downloaded with the computer contains the check query. The web page stored in the Internet server that contains the description of the implementation of the measurement sequence of the medical-technical system can be downloaded by a computer connected to the Internet, so that, for example, the operator of the medical-technical system can read the implementation of the measurement sequence. Moreover, the operator can review whether he or she has understood the implementation of the measurement sequence by the operator answering the check query. The check query is communicated either with the web page that contains the description of the implementation of the measurement sequence or with the further web page. The inventive system thus is implemented such that the operator can learn the measurement sequence in a simple way, for example at home, without having to attend an attendance seminar, and can check comprehension of the implementation of the new measurement sequence in a simple way. The inventive system thus allows the inventive method to be implemented with it. It is especially advantageous when it is used for follow-up training of the operator and/or when a new measurement sequence is learned with the inventive system.

In an embodiment of the system, wherein points according to a predetermined point system are awarded on the basis of an answer to the check query, the inventive system can be employed for the implementation of a test. The person being tested need not make an extra trip to the location at which the test is being given, for example a classroom.

### DESCRIPTION OF THE DRAWINGS

FIG. 1 shows a scenario that illustrates the inventive method and the inventive system.

FIG. 2 is a flowchart of an embodiment of the inventive method.

FIGS. 3 through 5 show web pages of the type employed in the inventive method.

### DESCRIPTION OF THE PREFERRED EMBODIMENTS

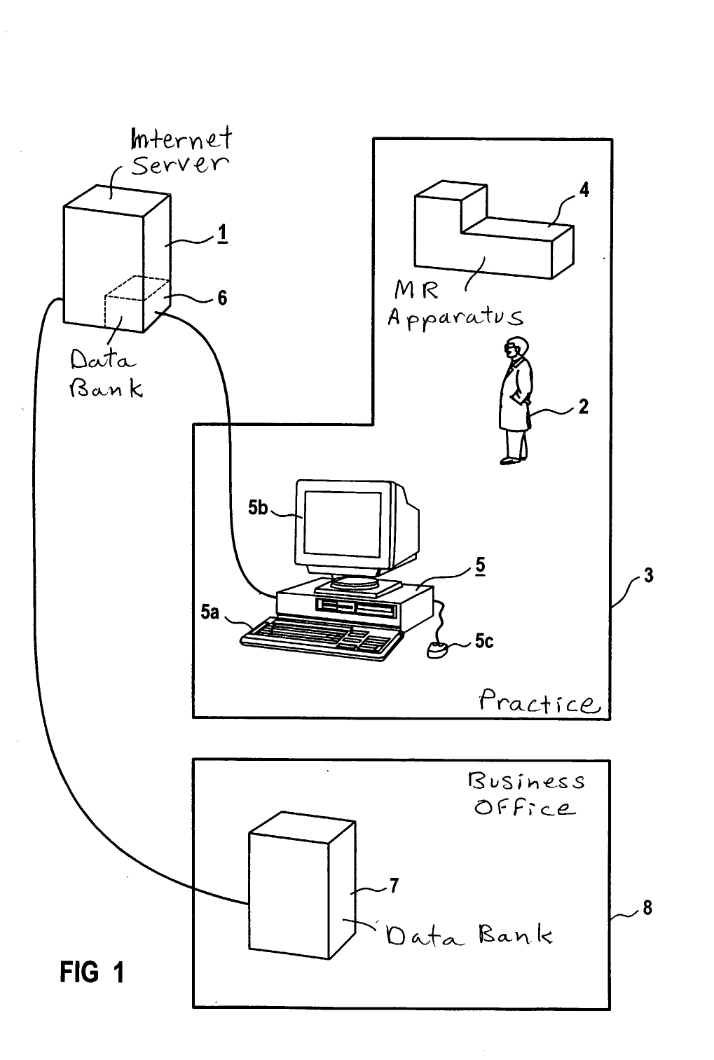

FIG. 1 shows an Internet server 1 that is maintained by a vendor for follow-up training for medical-technical systems that offers follow-up training for the operation of medical-technical systems via the Internet. To this end, the vendor for follow-up training for medical-technical systems offers web pages stored in the Internet server 1 that contain a description of a measurement sequence and an implementation of an operation of an medical-technical system allocated to the measurement sequence. The vendor of follow-up training for medical-technical systems offers, in particular, follow-up training for the implementation of new measurement sequences for medical-technical systems, i.e. for the implementation of measurement sequence that have been newly developed and are therefore not yet utilized as a standard. So that a participant can check his or her comprehension for the implementation of the operation of the medical-technical system on the basis of the new measurement sequence, the vendor of follow-up training for medical-technical system also offers web pages with the Internet server 1 that contain one or more review tasks relating to the described measurement sequence.

FIG. 1 also shows a radiologist 2 at a practice 3 who has a magnetic resonance apparatus 4 and a PC 5 connected to the Internet. In the exemplary embodiment, the magnetic resonance apparatus 4 and the PC 5 are located in the physician's practice 3.

In the exemplary embodiment, the radiologist 2 participates in follow-up training offered by the vendor of follow-up training for medical-technical system in order—in the exemplary embodiment—to learn a new measurement method for the operation of the magnetic resonance apparatus 4 without having to take part in an attendance seminar. The radiologist can comfortably participate in the follow-up training from the physician's practice 3.

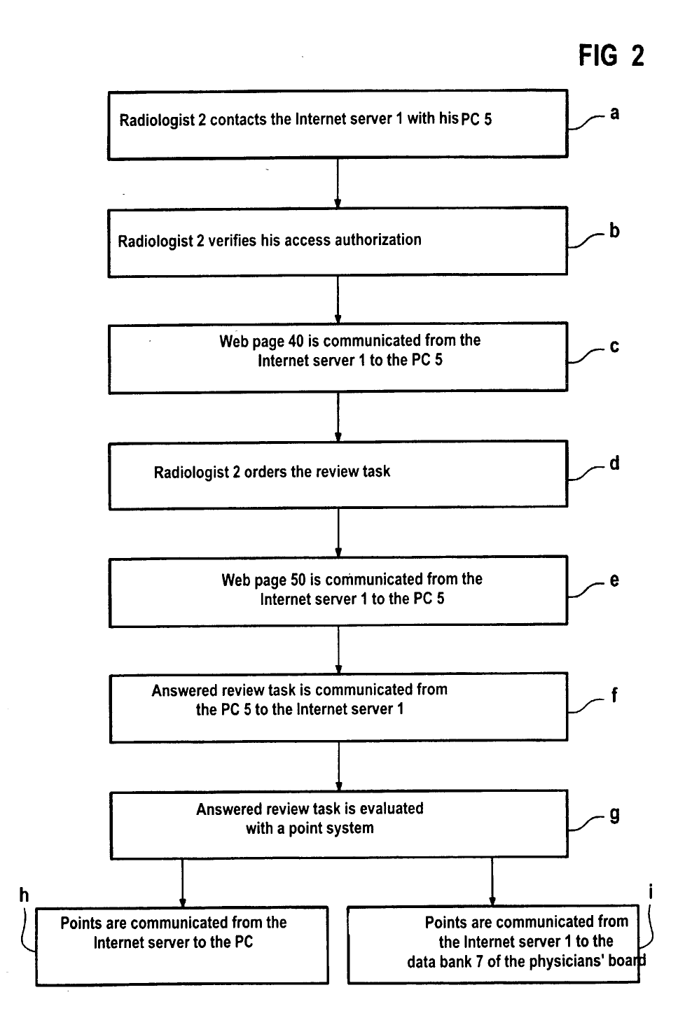

In the exemplary embodiment, the follow-up training is divided into five lessons. After the radiologist 2 has applied for follow-up training to the vendor of follow-up training for medical-technical systems, the radiologist 2 is assigned an identifier in order to be able to download the individual lessons of the follow-up training from the Internet server 1 with the computer 5. In the exemplary embodiment, the radiologist 2 has already studied the first lesson and now would like to study the second lesson. The radiologist 2 therefore uses the PC 5 to contact the Internet server 1 and verifies the access authorization by entering the assigned identifier via the keyboard 5a of the PC 5 and is communicated to the Internet server 1 (steps a and b in the flowchart shown in FIG. 2).

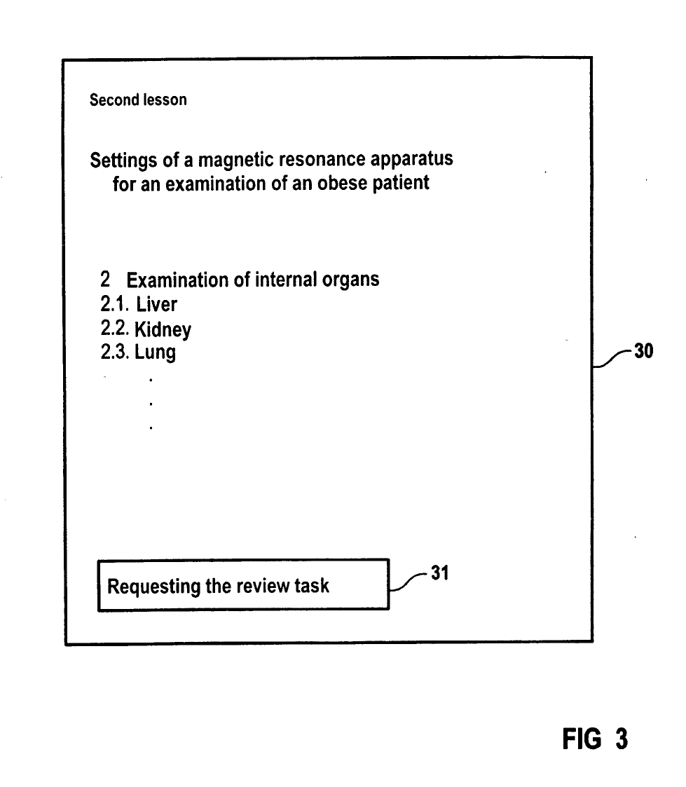

A suitable program stored in the Internet server subsequently recognizes the access authorization of the radiologist 2. The computer program always recognizes the follow-up training in which the radiologist 2 is participating and which lesson or, respectively, lessons of the follow-up training the radiologist 2 already has completed. Subsequently, the Internet server 1 communicates a web page 30 (schematically shown in FIG. 3) to the PC 5 that covers the second lesson of the follow-up training. In the present exemplary embodiment, the second lesson of the follow-up training describes a measurement sequence and the appertaining operation, i.e. a setting of the magnetic resonance apparatus 3 to be implemented by the radiologist 2 for very obese patients. After the web page 30 has been communicated to the PC, it takes shape on a monitor 5b of the PC 5, so that the radiologist 2 can study the second lesson of the follow-up training (step c of the flowchart shown in FIG. 2).

At the end of the second lesson, the radiologist 2 can check his or her comprehension of the measurement sequence that has been studied by clicking a field 31 of the web page 30 with a computer mouse 5c of the PC 5 in a well-known way (step d of the flowchart shown in FIG. 2).

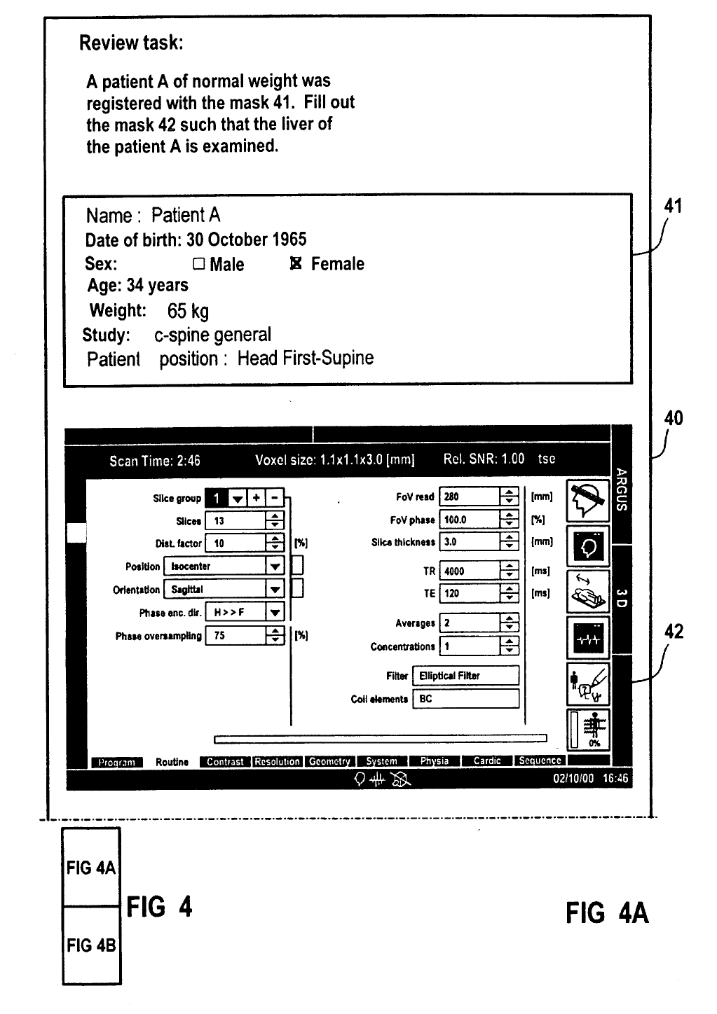

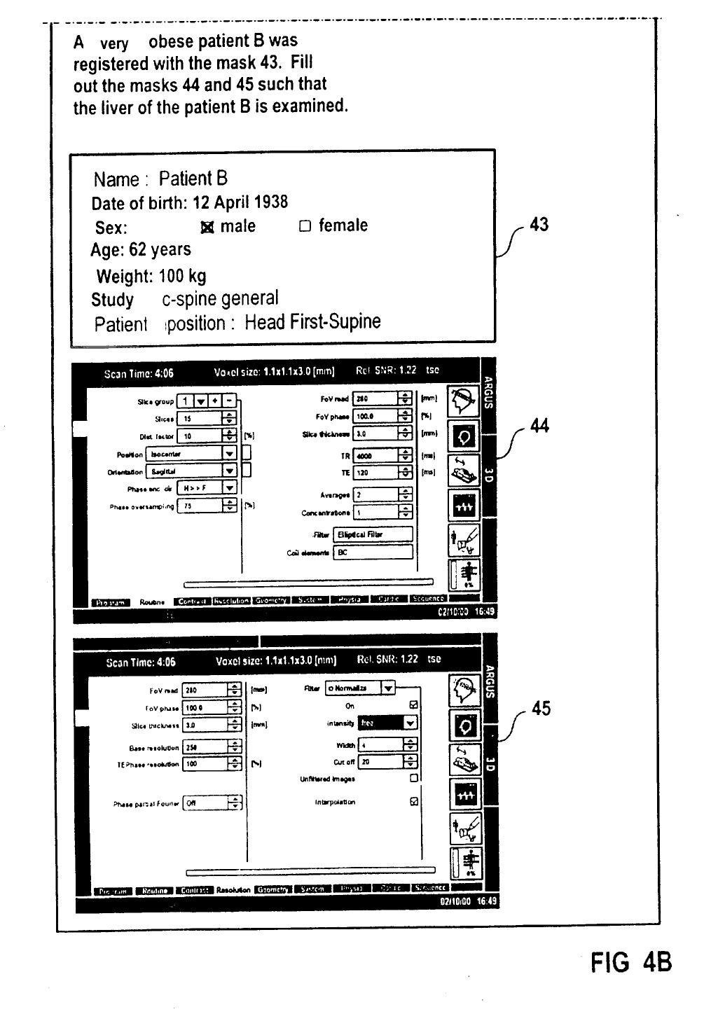

Subsequently, a further web page 40 (shown in FIG. 4) that covers a review task for the second lesson of the follow-up training is requested from the Internet server 1 (step e of the flowchart shown in FIG. 2).

In the exemplary embodiment, the Internet server 1 contains a data bank 6 in which several review tasks allocated to the individual lessons of the follow-up training are stored. The computer program stored in the Internet server 1 also is implemented such that it employs a random technique to communicate a review task allocated to the respective lesson and stored in the data bank 6 to the computer 5 with the web page 40; i.e. only a sub-set of review tasks allocated to the second lesson is communicated to the radiologist 2 according to the random technique. In the exemplary embodiment, the review task can also be locally stored by means of Java Script. Further, the review task is available to the radiologist 2 for only a specific time duration prescribed by the computer program stored in the Internet server, i.e. the radiologist 2 can only view the web page 40 for the specific time duration—10 minutes in the case of the exemplary embodiment—and process the review task.

On the basis of the review task reproduced in the web page 40, the radiologist 2 is first asked to simulate a setting of the magnetic resonance apparatus 4 the radiologist 2 wishes to examine the liver of a patient A of normal weight. To this end, the web page 40 has a mask 41 that already has been filled out and that corresponds to an input mask of the magnetic resonance apparatus that the radiologist 2 fills out before an examination of the patient A with the magnetic resonance apparatus 4. The web page 40 has a further mask 42 that corresponds to a further input mask of the magnetic resonance apparatus 4 with which a measurement sequence of the magnetic resonance apparatus 4 is defined. In the exemplary embodiment, the radiologist 2 is asked to fill out the mask 42 with suitable parameters that are allocated to a suitable measurement sequence for examining the liver of the patient A. The mask 42 of the web page 40 shown in FIG. 4, moreover, is shown already filled out.

The web page 40 shown in FIG. 4 also shows a mask 43 that contains entered data that are allocated to a very obese patient B. The web page 40 also contains further masks 44 and 45 that the radiologist 2 must fill out with suitable parameters that are allocated to an examination of the liver of the patient B with the magnetic resonance apparatus 4. The masks 44 and 45 are likewise shown in FIG. 4 as having been already filled out by the radiologist.

As described above, the radiologist 2 has 10 minutes to answer the review task of the web page 40, i.e. to fill out the masks 42, 44 and 45. After the 10 minutes have expired, the web page 40 processed by the radiologist is automatically transmitted from the PC 5 to the Internet server 1 and is no longer available on the PC 5 (step f of the flowchart shown in FIG. 2).

In the exemplary embodiment, further, the computer program stored in the Internet server 1 is configured such that it compares the answer of the radiologist 2 to a solution of the review task stored in the data bank 6 and automatically rates it on the basis of a point system. In the exemplary embodiment, the computer program stored in the Internet server awards more points when the answer of the radiologist 2 is correct and fewer points when the answer is wrong (step g of the flowchart shown in FIG. 2).

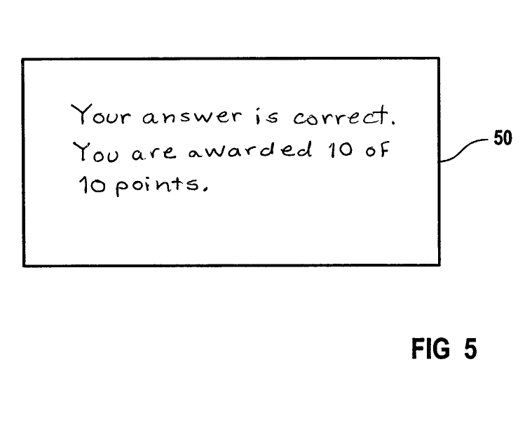

Subsequently, the computer program communicates the points that were achieved to the radiologist 2 with a web page 50 shown in FIG. 5. In the exemplary embodiment, the radiologist 2 correctly answered the review task, for which reason the radiologist 2 is awarded the maximally obtainable number of points, 10 of 10 points in the exemplary embodiment. The number of points the radiologist 2 achieved also is stored in the data bank 5 (step 5 of the flow chart shown in FIG. 2).

In the exemplary embodiment, the computer program stored in the Internet server 1 subsequently communicates the number of points of the radiologist 2 together with his or her identity from the Internet server 1 to a data bank 7 connected to the Internet, said data bank 7 being allocated to a physicians' board and being located in a business office 8 of the physicians' board (step i of the flowchart shown in FIG. 2).

The points awarded to the radiologist 2 that the radiologist 2 achieved by answering a review task that is allocated to the first lesson of the follow-up training are also stored in the data bank 7. Accordingly, it is possible to check, on the basis of the awarded points, whether the radiologist is successfully participating in the follow-up training. Such a check can then be employed by the physicians' board to permit, for example, the radiologist 2 to undertake specific examinations with his or her magnetic resonance apparatus 4.

In the exemplary embodiment, the radiologist 2 had to verify his or her access authorization with an identifier before the download of the web page 40. This identifier can also ensue, for example, with a sensor arranged at the keyboard 5a of the PC 5 for registering a fingerprint of the radiologist 2 or can ensue with a memory card, a magnetic card or a chip card.

The web page 30 that contains the description of the measurement sequence of the magnetic resonance apparatus can also contain the review task. The web page 40 can also contain more than one review task.

The Internet server 1 need not necessarily be operated by a vendor for follow-up training for medical-technical system. It is also possible for the Internet server to be operated by the physicians' board or some other professional society.

The points that have been achieved can be stored on the memory card. More than one review task can be posed.

In the exemplary embodiment, a follow-up training for a magnetic resonance apparatus has been described. The inventive method, however, can be employed for other medical-technical systems.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for learning an implementation of a measuring sequence for operating a medical-technical system, comprising the steps of:
maintaining a first web page on an Internet server and including in said first web page a description for implementing a measurement sequence for operating a medical-technical system;
communicating said first web page to a computer via the Internet and thereby allowing said first web page to be displayed at a viewing device of said computer;
maintaining a second web page on said Internet server and including in said second web page at least one check query regarding said implementation of said measurement sequence; and
communicating said second web page to said computer via the Internet and thereby allowing said second web page to be displayed at said viewing device of said computer.

2. A method as claimed in claim 1 comprising the additional steps of:
entering an answer via said computer to said check query;
establishing a point system for awarding a selected number of points respectively to different answers to said check query; and
awarding points dependent on said point system to said answer entered via said computer.

3. A method as claimed in claim 2 comprising the additional step of forwarding said points from said Internet server to an accreditation entity.

4. A method as claimed in claim 1 comprising automatically selecting said check query from a query catalog according to a random technique.

5. A method as claimed in claim 1 comprising requiring said check query to be answered within a predetermined time duration.

6. A method as claimed in claim 1 wherein the step of maintaining a first web page comprises maintaining a first web page on an Internet server and including in said first web page a description for the implementation of a measurement sequence for operating a magnetic resonance apparatus.

7. A system for learning an implementation of a measuring sequence for operating a medical-technical system, comprising the steps of:
an Internet server which maintains a first web page that includes a description for implementing a measurement sequence for operating a medical-technical system;
a computer to which said first web page to a computer from said server via the Internet, said first web page being displayed at a viewing device of said computer;
said Internet server also maintaining a second web page at least one check query regarding said implementation of said measurement sequence; and
said second web page also being to said computer from said server via the Internet, said second web page being displayed at said viewing device of said computer; and
an interface unit at said computer via which an answer to said check query to be entered and sent from said computer to said Internet server via the Internet.

8. A system as claimed in claim 7 comprising a point system established at said Internet Server for awarding a selected number of points respectively to different answers to said check query wherein said Internet server awards points dependent on said point system to said answer entered via said computer.

9. A system as claimed in claim 8 wherein said Internet server forwards said points from said Internet server to an accreditation entity.

10. A system as claimed in claim 7 wherein said Internet server automatically selects said check query from a query catalog according to a random technique.

11. A system as claimed in claim 7 wherein said Internet server requires said check query to be answered within a predetermined time duration.

12. A system as claimed in claim 7 wherein the first web page maintained said Internet server and includes a description for the implementation of a measurement sequence for operating a magnetic resonance apparatus.
